(19) United States
(12) Patent Application Publication
(10) Pub. No.: US 2001/0037426 A1
(43) Pub. Date: Nov. 1, 2001

(54) Interrupt handling via a proxy processor

(76) Inventors: Chester W. Pawlowski, Westford, MA (US); Stephen F. Shirron, Acton, MA (US); Stephen R. Van Doren, Northborough, MA (US)

Correspondence Address: CESARI AND MCKENNA, LLP, 88 BLACK FALCON AVENUE, BOSTON, MA, 02210, US

(21) Appl. No.: 09/837,833

(22) Filed: Apr. 18, 2001

Related U.S. Application Data
(60) Provisional application No. 60/208,341, filed on May 31, 2000.

(51) Int. Cl. G06F 13/24

(52) U.S. Cl. 710/260

(57) ABSTRACT

A translation technique facilitates servicing of device interrupts by a proxy processor of a multiprocessor system having an interrupt delivery/handling subsystem. A target processor of the system is originally designated to service the interrupts, whereas the proxy processor is configured to service the interrupts in response to hot-swap of the target processor. The translation technique provides dual mapping of a device interrupt queue (DIQ) associated with the target processor and used to store vectors describing the device interrupts. The dual mapping technique allows the DIQ to be accessed via either a “fast access” or “slow access” mode. The fast access mode provides optimized access to the DIQ by the target processor via processor-specific space addressing, whereas the slow access mode provides slower, yet flexible, access to the DIQ by any other processor, such as the proxy processor, via general system space addressing.

### CROSS-REFERENCE TO RELATED APPLICATIONS

The present application claims priority from U.S. Provisional Patent Application Ser. No. 60/208,341, which was filed on May 31, 2000, by Chester Pawlowski, Stephen Shirron and Stephen Van Doren for an INTERRUPT HANDLING VIA A PROXY PROCESSOR and is hereby incorporated by reference.

### BACKGROUND OF THE INVENTION

1. Field of the Invention

The invention relates generally to multiprocessor systems and, in particular, to the delivery and handling of device interrupts by a processor of a multiprocessor system.

2. Background Information

Device interrupts are typically generated by input/output (I/O) devices of a multiprocessor system in response to detection of errors by those devices. In a conventional bus-based system, the interrupts may be manifested as interrupt signals that are asserted IS over the bus and provided to a single agent of the system, such as a processor, designated to service the interrupts. To ensure that only the processor designated to service the errors receives the interrupt signals, a control and status register (CSR) located on each processor may be used to “mask” the asserted signals if the processor is not designated to receive the signals.

In a modular multiprocessor system, the processors may be distributed over physically remote subsystems that are interconnected by a switch fabric. These large systems may further be configured according to a distributed shared memory (DSM) or a non-uniform memory access (NUMA) paradigm. Device interrupts are preferably geted to a processor of the system that is designated to service the interrupts, thereby avoiding interrupts directed to multiple processors for the same event. To that end, an operating system may be configured to interrupt only the designated processor of the system in response to an error event.

Specifically, the I/O subsystem notifies the designated processor of a pending device interrupt and, in response to a request for additional information about the interrupt, provides the designated processor with a descriptor or vector. The vector indicates to the processor which I/O device is the source of the interrupt. In particular, the vector allows the operating system running on the processor to determine the type and location of the interrupting device; thereafter, the operating system may initiate execution of an appropriate service routine to respond to the device's needs.

System performance may be constrained by the efficiency of the interrupt service response described above. Performance of the interrupt response can be enhanced by storing pending interrupt vectors near the designated (i.e., target) processor in, e.g., an interrupt queue and by optimizing access to those vectors by the processor. Yet, such a configuration presents a problem when “hot-swapping” a system component, such as the target processor. Specifically, the target processor must be hot-swapped (i.e., removed or reconfigured) without disturbing operation of the system. Yet during the removal or reconfiguration procedure, the target processor may not be able to service interrupts previ ously dispatched to its interrupt queue. If these interrupts cannot be serviced, the target processor cannot be cleanly removed from the system and the interrupts will be lost.

Generally, multiprocessor systems have not supported hot swapping of processors. For those that do support hot-swap, the multiprocessor systems typically provide interrupt vectors to the target processors from a more remote, but central queuing location. In this latter case, hot swap transitioning may proceed correctly, but normal system operation and, more specifically, performance may be compromised. The present invention is directed to a technique for maintaining efficient servicing of interrupts by processors in a multiprocessor system that supports hot swap of the processors.

### SUMMARY OF THE INVENTION

The present invention comprises a translation technique that facilitates servicing of interrupts by a proxy processor of a multiprocessor system having an interrupt delivery/handling subsystem. The multiprocessor system comprises a plurality of processors, including a target processor originally designated to service the interrupts. The proxy processor is configured to service the interrupts in response to hot-swap of the target processor. The interrupts are preferably device interrupts that are generated by input/output (I/O) devices of an I/O subsystem within the multiprocessor system.

According to the invention, the translation technique provides dual mapping of a device interrupt queue (DIQ) associated with the target processor and used to store vectors describing the device interrupts. The dual mapping technique allows the DIQ to be accessed via either a “fast access” or “slow access” mode. The fast access mode provides optimized access to the DIQ by the target processor via processor-specific space addressing, whereas the slow access mode provides slower, yet flexible, access to the DIQ by any other processor, such as the proxy processor, via general system space addressing.

The translation technique also provides dual decoding of a mask register in the I/O subsystem that is used to indicate pending interrupts provided to the target processor. As described herein, the mask register is preferably a sent interrupt (sent_int) register associated with the target processor. The target processor completes servicing of a pending interrupt by clearing a bit in the sent_int register corresponding to that interrupt. The dual decoding technique allows the proxy processor to clear the bit of the sent_int register corresponding to a serviced interrupt through the use of an alternate sent interrupt (alt_sent_int) register that is mapped to the sent_int register. These inventive techniques enable the proxy processor to service pending interrupts of the target processor in an efficient and accurate manner.

### BRIEF DESCRIPTION OF THE DRAWINGS

The above and further advantages of the invention may be better understood by referring to the following description in conjunction with the accompanying drawings, in which like reference numbers indicated identical or functionally similar elements:

FIG. 1 is a schematic block diagram of a modular, symmetric multiprocessing (SMP) system having a plurality of Quad Building Block (QBB) nodes and an input/output (I/O) subsystem interconnected by a hierarchical switch (HS);

FIG. 2 is a schematic block diagram of a QBB node of FIG. 1;

FIG. 3 is a schematic block diagram of the I/O subsystem of FIG. 1;

FIG. 4 is a schematic block diagram of an interrupt delivery/handling subsystem that may be advantageously used with the present invention; and

FIG. 5 is a schematic block diagram of an interrupt packet that may be advantageously used with the present invention.

### DETAILED DESCRIPTION OF AN ILLUSTRATIVE EMBODIMENT

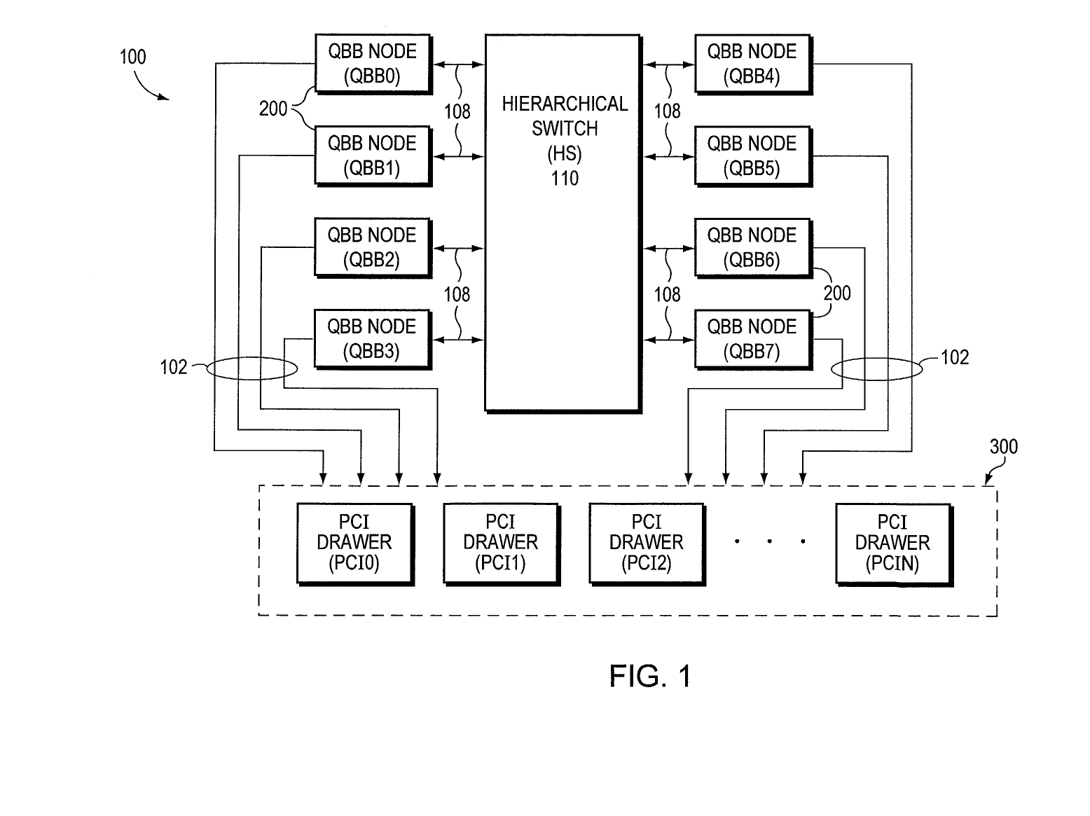

FIG. 1 is a schematic block diagram of a modular, symmetric multiprocessing (SMP) system 100 having a plurality of nodes 200 interconnected by a hierarchical switch (HS) 110. The SMP system further includes an input/output (I/O) subsystem 300 comprising a plurality of I/O enclosures or “drawers” configured to accommodate a plurality of I/O buses that preferably operate according to the conventional Peripheral Computer Interconnect (PCI) protocol. The PCI drawers are connected to the nodes through a plurality of I/O interconnects or “hoses” 102.

In the illustrative embodiment described herein, each node is implemented as a Quad Building Block (QBB) node 200 comprising, inter alia, a plurality of processors, a plurality of memory modules, a directory, an I/O port (IOP), a plurality of I/O risers and a global port (GP) interconnected by a local switch. Each memory module may be shared among the processors of a node and, further, among the processors of other QBB nodes configured on the SMP system to create a distributed shared memory (DSM) or a nonuniform memory access (NUMA) environment. A fully configured SMP system preferably comprises eight (8) QBB (QBB0-7) nodes, each of which is coupled to the HS 110 by a full-duplex, bi-directional, clock forwarded HS link 108.

Data is transferred between the QBB nodes 200 of the system 100 in the form of packets. In order to provide a DSM or NUMA environment, each QBB node is configured with an address space and a directory for that address space. The address space is generally divided into memory address space and I/O address space. The processors and IOP of each QBB node utilize private caches to store data for memory-space addresses; I/O space data is generally not “cached” in the private caches.

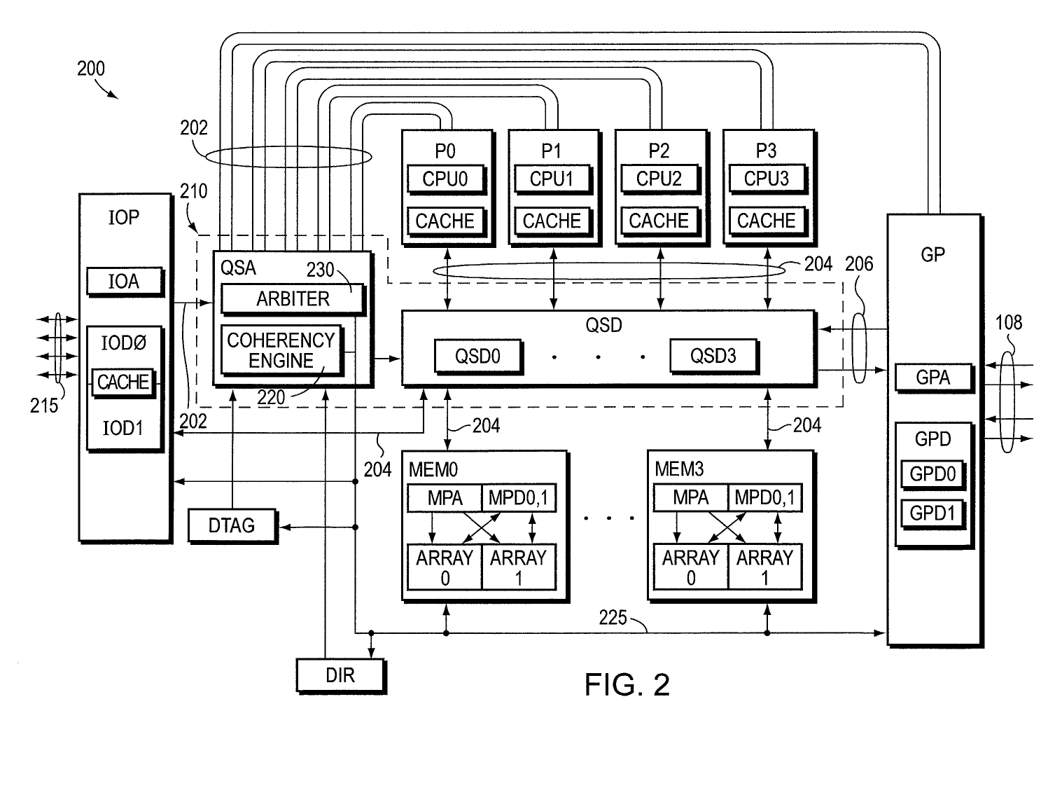

FIG. 2 is a schematic block diagram of a QBB node 200 comprising a plurality of processors (P0-P3) coupled to the IOP, the GP and a plurality of memory modules (MEM0-3) by a local switch 210. The memory may be organized as a single address space that is shared by the processors and apportioned into a number of blocks, each of which may include, e.g., 64 bytes of data. The IOP controls the transfer of data between external devices connected to the PCI drawers and the QBB node via the I/O hoses 102. As with the case of the SMP system, data is transferred among the components or “agents” of the QBB node 200 in the form of packets. As used herein, the term “system” refers to all components of the QBB node excluding the processors and IOP.

Each processor is a modem processor comprising a central processing unit (CPU) that preferably incorporates a traditional reduced instruction set computer (RISC) load/store architecture. In the illustrative embodiment described herein, the CPUs are Alpha® 21264 processor chips manufactured by Compaq Computer Corporation, although other types of processor chips may be advantageously used. The load/store instructions executed by the processors are issued to the system as memory reference transactions, e.g., read and write operations. Each operation may comprise a series of commands (or command packets) that are exchanged between the processors and the system.

In addition, each processor and IOP employs a private cache for storing data determined likely to be accessed in the future. The caches are preferably organized as write-back caches apportioned into, e.g., 64-byte cache lines accessible by the processors; it should be noted, however, that other cache organizations, such as write-through caches, may be advantageously used. It should be further noted that memory reference operations issued by the processors are preferably directed to a 64-byte cache line granularity. Since the IOP and processors may update data in their private caches without updating shared memory, a cache coherence protocol is utilized to maintain data consistency among the caches.

In the illustrative embodiment, the logic circuits of each QBB node are preferably implemented as application specific integrated circuits (ASICs). For example, the local switch 210 comprises a quad switch address (QSA) ASIC and a plurality of quad switch data (QSD0-3) ASICs. The QSA receives command/address information (requests) from the processors, the GP and the IOP, and returns command/address information (control) to the processors and GP via 14-bit, unidirectional links 202. The QSD, on the other hand, transmits and receives data to and from the processors, the IOP and the memory modules via 72-bit, bi-directional links 204.

Each memory module includes a memory interface logic circuit comprising a memory port address (MPA) ASIC and a plurality of memory port data (MPD) ASICs. The ASICs are coupled to a plurality of arrays that preferably comprise synchronous dynamic random access memory (SDRAM) dual in-line memory modules (DIMMs). Specifically, each array comprises a group of four SDRAM DIMMs that are accessed by an independent set of interconnects.

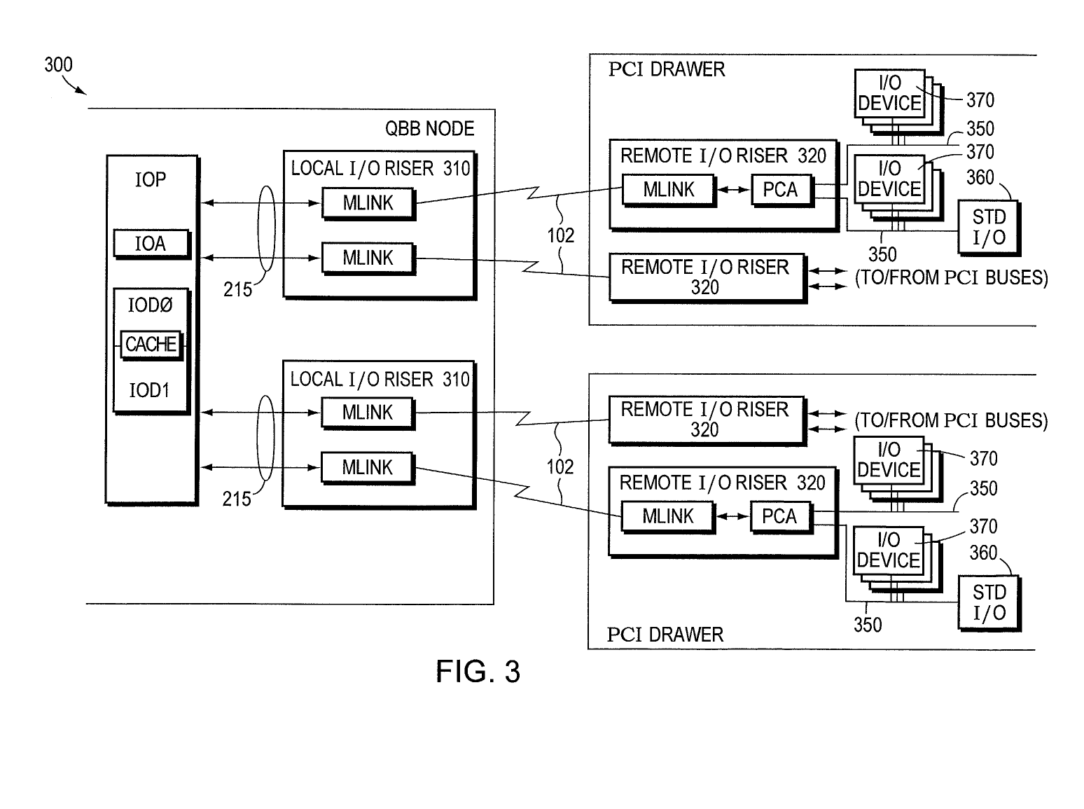

The IOP preferably comprises an I/O address (IOA) ASIC and a plurality of I/O data (IOD0-1) ASICs that collectively provide an I/O port interface from the I/O subsystem to the QBB node. The IOP is connected to a plurality of local I/O risers (FIG. 3) via I/O port connections 215, while the IOA is connected to an IOP controller of the QSA and the IODs are coupled to an IOP interface circuit of the QSD. In addition, the GP comprises a GP address (GPA) ASIC and a plurality of GP data (GPD0-1) ASICs. The GP is coupled to the QSD via unidirectional, clock forwarded GP links 206. The GP is further coupled to the HS 110 via a set of unidirectional, clock forwarded address and data HS links 108.

A plurality of shared data structures are provided for capturing and maintaining status information corresponding to the states of data used by the nodes of the system. One of these structures is configured as a duplicate tag store (DTAG) that cooperates with the individual hardware caches of the system to define the coherence protocol states of data in the QBB node. The other structure is configured as a directory (DIR) to administer the distributed shared memory environment including the other QBB nodes in the system. Illustratively, the DTAG functions as a “short-cut” mechanism for commands at a “home” QBB node, while also operating as a refinement mechanism for the coarse protocol state stored in the DIR at “target” nodes in the system. The protocol states of the DTAG and DIR are managed by a coherency engine 220 of the QSA that interacts with these structures to maintain coherency of cache lines in the SMP system 100.

The DTAG, DIR, coherency engine, IOP, GP and memory modules are interconnected by a logical bus, hereinafter referred to as an Arb bus 225. Memory and I/O reference operations issued by the processors are routed by an arbiter 230 of the QSA over the Arb bus 225. The coherency engine and arbiter are preferably implemented as a plurality of hardware registers and combinational logic configured to produce sequential logic circuits, such as state machines. It should be noted, however, that other configurations of the coherency engine, arbiter and shared data structures may be advantageously used.

FIG. 3 is a schematic block diagram of the I/O subsystem 300 comprising a plurality of local and remote I/O risers 310, 320 interconnected by I/O hoses 102. The local I/O risers 310 are coupled directly to QBB backplanes of the QBB nodes 200, whereas the remote I/O risers 320 are contained within PCI drawers of the I/O subsystem. Each local I/O riser preferably includes two local Mini-Link copper hose interface (MLINK) ASICs that couple the I/O ports 215 to local ends of the I/O hoses. Each PCI drawer includes two remote I/O risers 320, each comprising one remote MLINK that connects to a far end of the I/O hose 102. The I/O hose comprises a “down-hose” path and an “up-hose” path to enable a full duplex, flow-controlled data path between the PCI drawer and IOP. The remote MLINK also couples to a PCI bus interface (PCA) ASIC that spawns two PCI buses 350, a first having three slots and a second having four slots for accommodating I/O devices 370. The first slot of first PCI bus is preferably reserved for a standard I/O module 360.

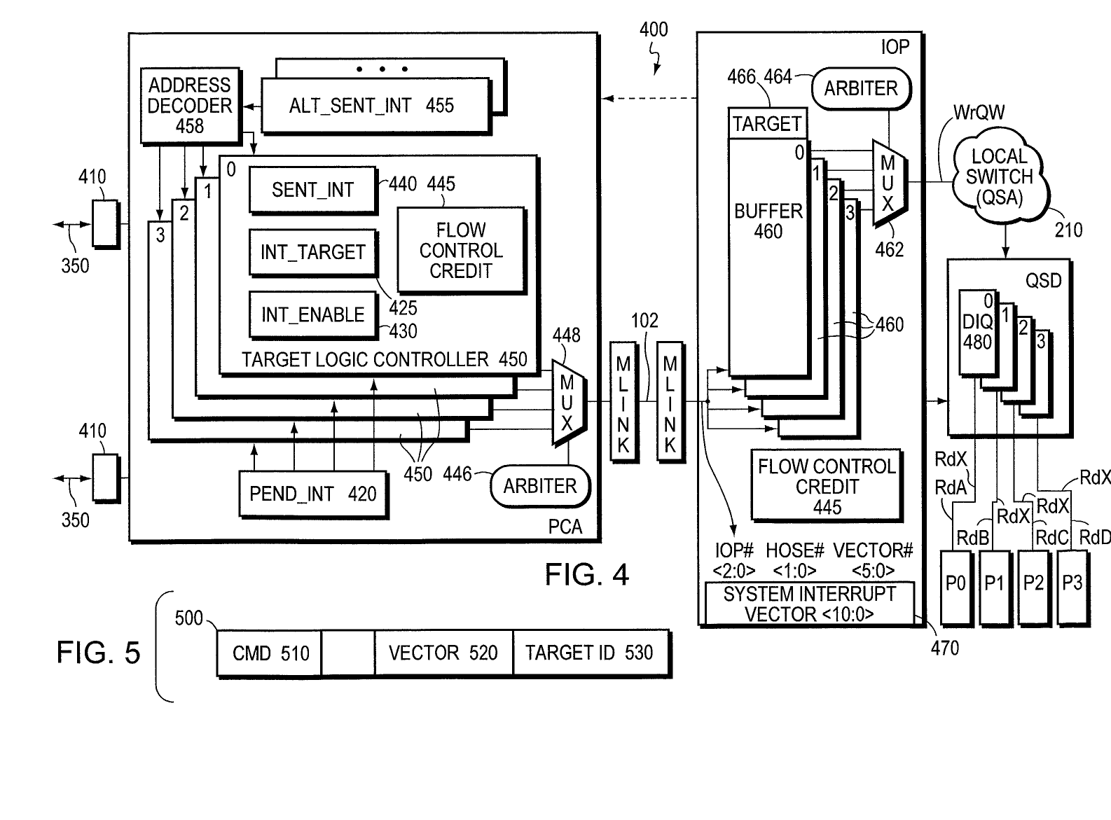

The present invention comprises a translation technique that facilitates servicing of device interrupts by a proxy processor of a multiprocessor system having an interrupt delivery/handling subsystem. FIG. 4 is a schematic block diagram of the interrupt delivery/handling subsystem 400 that may be advantageously used with the present invention. The subsystem 400 is preferably optimized for normal operation in the SMP system, although it is also configured for proper operation in situations where the processor designated to service interrupts (the target processor) is “hot swapped” from the system.

Typically, when a target processor receives a device interrupt, it first determines which I/O device 370 is the source of the interrupt so that it can invoke an appropriate driver (“interrupt handler”) to respond to the interrupt. To increase the efficiency of this determination, information, such as the identification (ID) of the I/O device issuing the interrupt, is provided to the processor along with the interrupt. Armed with the ID of the I/O device generating the interrupt, the processor can quickly perform a lookup operation into a database (not shown) to determine the type of device generating the interrupt and the appropriate interrupt handler needed to service the interrupt. Thereafter, the target processor executes the handler code to service the interrupt.

In the illustrative embodiment, the interrupt delivery/handling subsystem 400 comprises an arrangement of interrupt queues and registers that enable the delivery of vectors to the appropriate processor or processors servicing the device interrupts. In this context, a vector is a descriptor that indicates to the target processor the I/O device in the I/O subsystem that is the source of the interrupt. The vector allows the operating system running on the processor to determine the type and location of the interrupting I/O device; the operating system may then initiate execution of an appropriate service routine to respond to the device's needs.

The I/O devices 370 coupled to the PCI bus 350 preferably deliver level sensitive interrupt (LSI) signals over the bus to a conventional intermediary device 410, such as an interrupt controller, that gathers the interrupts and provides them to the PCA ASIC of the I/O subsystem 300. The intermediary device 410 essentially translates the LSI signals into an encoded message that is delivered to the PCA. Specifically, a pending interrupt (pend_int) register 420 stores the encoded message received from the intermediary device. The pend_int register 420 comprises a plurality of bits representing interrupts that may be generated from the PCI bus, including interrupts that may be generated from the standard I/O module 360. In the illustrative embodiment, the pend_int register comprises 32 bits representing 32 possible interrupts generated by as many as four I/O devices 370 coupled to the PCI bus 350. These 32 interrupts are allocated among the four PCI devices 370 such that each device may issue up to 8 different LSI signals. For example in response to a LSI signal issued by an I/O device over the PCI bus, the intermediary device 410 encodes a message indicating that a particular interrupt (e.g., interrupt #7) has been asserted on the bus. In response to the encoded message, the PCA asserts a bit in the pend_int register 420 corresponding to interrupt #7. Thus for every interrupt encoded within the message, a corresponding bit in the pend_int register 420 is asserted.

Assume a number of interrupts are asserted over the PCI bus 350 and the intermediary device 410 translates those interrupts into encoded messages that result in the assertion of a number of bits in the pend int register 420 of the PCA. The PCA attempts to deliver these pending interrupts to target processors in the SMP system so that they can be serviced. In the illustrative embodiment, up to four processors may be targeted for servicing these interrupts. To that end, the PCA comprises four independent target logic controllers 450, each configured to steer a pending interrupt to a target processor in the SMP system 100.

Each target logic controller 450 includes an interrupt target (int_target) register 425. The int_target registers specify up to four processors, located anywhere in the SMP system, as possible targets of device interrupts propagated by the PCA. The target logic controllers also include interrupt enable (int_enable) registers 430 that control which PCA interrupts are sent to which target processors. Each int_target register 425 cooperates with a corresponding int_enable register 430 such that the content of the int_enable register enables interrupts to be sent to the target processor specified by the content of the corresponding int_target register.

In the illustrative embodiment, the int_enable registers 430 preferably contain mutually exclusive masks that further cooperate with the pend_int register 420. That is, the 32 interrupts pending within the pend_int register 420 are apportioned among the four target logic controllers 450 by the four masks of the int_enable registers 430. As noted, the int_target register 425 associated with each target logic controller identifies a particular target processor for servicing certain interrupts pending in the pend_int register. For example, int_target register 0 of target logic controller 0 may target processor 0 (P0) of the SMP system for servicing certain interrupts. In the case a primary processor, one of the int_target registers of a target logic controller may be programmed to target the primary processor by, e.g., asserting all bits of the int_enable mask for that processor. The int_target registers for the other target logic controllers do not have to be programmed because there are no bits asserted in their int_enable registers.

Each target logic controller 450 also includes flow control credit logic 445 for determining when there is sufficient buffers 460 within the IOP for receiving interrupts from the PCA. Thus, the target logic controllers “logically combine” the pending interrupt bits asserted in the pend_int register 420 with the masks in their int_enable registers 430 to determine whether there are any pending interrupts destined for the target processor. If so, the target logic controllers examine their flow control credits 445 to determine whether there are sufficient buffers 460 in the IOP for accommodating those pending interrupts. If there are insufficient flow credits, the target logic controllers wait until there are sufficient flow credits in order to propagate their interrupts to their appropriate target processors.

A multiplexer (mux) 448 is used to couple the PCA to the IOP. The multiplexer 448 has a plurality of inputs, each coupled to a target logic controller 450, and an output coupled to the buffers 460 of the IOP. An arbiter 446 controls the selection of inputs at the multiplexer through an arbitration policy that is preferably round robin. The round robin policy is preferred because all of the interrupts are of a single class; that is, they are all device interrupts.

Each buffer 460 in the IOP is configured to receive interrupts from the PCA. In particular, each buffer is associated with a target logic controller and, ultimately, a target processor in the SMP system. Thus, each target logic controller 450 in the PCA has a corresponding target buffer 460 in the IOP and a flow control mechanism 445 is used to regulate the flow of traffic (interrupts) between them. The IOP buffers 460 are configured as “pipelines” wherein the contents of the buffers (the interrupts) are passed from the IOP through the local switch 210 and onto the appropriate target processor.

When a determination is made that there is sufficient flow credits to transfer a pending interrupt to the IOP, the target logic controller 450 asserts an appropriate bit in a sent_int register 440 of the target logic controller. The content of the sent_int register 440 is preferably a mask that summarizes interrupts that have been sent from the PCA to the target processor. When an interrupt is sent to a target processor, a corresponding bit in the mask of the sent_int register 440 is asserted. The content of the pend_int register 420 is then “masked” with the content of the sent_int register 440 in order to determine which pending interrupts have been sent to the target processor. The sent_int register ensures that the target logic controller 450, when seeking new pending interrupts to report to the target processor, does not send the same pending interrupt twice.

When servicing an interrupt, the interrupt service routine, e.g., an interrupt service handler or driver, executing on the target processor instructs the I/O device 370 generating the interrupt on the PCI bus 350 to deassert its LSI signal. In response, the interrupt controller 410 sends a message to the PCA directing it to clear the bit in the pend_int register 420 corresponding to the I/O device. Thereafter, the driver clears the appropriate bit of the sent_int register 440. The present invention is directed, in part, to a technique for clearing the sent int register in the PCA.

Once the interrupts have been delivered to the IOP, a queuing subsystem of the interrupt delivery/handling system delivers those interrupts to the appropriate target processors. Each pending interrupt is delivered to the IOP by way of an interrupt packet transmitted over the I/O hose 102. FIG. 5 is a schematic block diagram of the interrupt packet 500 comprising a command (cmd) field 510 whose content denotes the interrupt, a 6-bit vector field 520 and a target ID field 530. The 6-bit vector is an encoded descriptor that indicates to the target processor which I/O device is the source of the interrupt. The command interrupt packet 500 actually comprises two parts: one for the IOA (the address part) and the other for the IOD (the data part). In particular, the data (the vector 520) is provided to the IOD, whereas the address portion (the target ID 530) is provided to the IOA. The target ID 530 is compared with target IDs 466 of the various buffers 460 and, upon a match, is loaded into the appropriate buffer.

Once the interrupt packet 500 is received at the IOP, the 6-bit vector is parsed and combined with a 2-bit hose number and a 3-bit IOP number to form an 11-bit system interrupt vector 470. The 2-bit hose number specifies one of four I/O hoses 102 coupled to the IOP, whereas the 3-bit IOP number specifies one of the eight IOPs (QBBs) in the system. The 11-bit system interrupt vector 470 is enqueued within a buffer 460 of the IOP and delivered to the QSD coupled to the target processor. When examined by the target processor, the system interrupt vector indicates a particular interrupt from a particular device on a PCI bus coupled to a particular I/O hose that is coupled to a particular IOP in the SMP system.

The system interrupt vector 470 is delivered to the QSD over the local switch 210 as a system interrupt vector command having an address (QSA) component and a data (QSD) component. Broadly stated, the IOP issues a system interrupt vector command to the QSA. In response, the QSA issues a write quadword (WrQW) operation over the Arb bus 225 that results in the QSD instructing the IOP to send it some data. If the target processor is a local processor, the instruction from the QSD results in the data being moved directly to the QSD and stored in an interrupt buffer or queue of the QSD.

Notably, the command packet forwarded over the I/O hose 102 is an interrupt packet 500, whereas the command packet issued from the IOP to the local switch is a WrQW packet. The command issued to the local switch is a standard control and status register (CSR) write command. If the target processor is a remote processor (i.e., on another QBB node of the SMP system), the CSR write command is forwarded from the local switch 210 over the HS 110 to the GP of the remote QBB node 200. The CSR write command is then transferred over the local switch and into an interrupt queue of the QSD that corresponds to the target processor. Specifically, each QSD ASIC (QSD 0-3) includes a device interrupt queue (DIQ) 480 that corresponds to a particular processor. The DIQs are preferably located in processor interface circuits of the QSD. For example, DIQO is located in QSDO and corresponds to P0, DIQ1 is located in QSD1 and corresponds to P1 and so on. Therefore, interrupts that are targeted to P0 are enqueued into the DIQ 480 located on QSDO.

According to the invention, the translation technique provides dual mapping of the DIQ 480 associated with a target processor and used to store vectors describing the device interrupts. The dual mapping technique allows each DIQ 480 to be accessed via either a “fast access” or “slow access” mode. The fast access mode provides optimized access to the DIQ by the target processor via processor-specific space addressing, whereas the slow access mode provides slower, yet flexible, access to the DIQ by any other processor, such as the proxy processor, via general system space (i.e., standard register access) addressing.

In the illustrative embodiment, there is a region of CSR address space in the SMP system that is bound to specific processors; this region of CSR space is referred to as “fast access CSRs”. Typically, each fast access CSR is addressed by a unique register address. In addition, the fast access CSR is mapped such that it resides in a processorspecific address space. In this latter addressing mode, each processor may access the vector stored in its fast access CSR or DIQ by performing a read operation of x (Rd x) where x is the same value (i.e., the same register address) regardless of the processor's ID. However, the fast access CSRs operate such that processor P0 reads only its DIQ0, processor P1 reads only its DIQ1, and so on.

The IOP and, in the case of a remote target processor, the GP both “snoop” the Arb bus 225 for purposes of flow controlling the DIQs in the QSDs. For example, when the IOP issues a WrQW command to a DIQ in the QSD, it asserts a flow control credit. Thereafter, when the IOP monitors the Arb bus and observes that the processor has read the contents of that DIQ, it deasserts the credit. The same type of flow control mechanism is used with respect to the GP on a remote node when it loads an interrupt vector into a DIQ in the QSD corresponding to the remote processor.

The target ID 530 is essentially the address portion of the interrupt packet 500 since the addresses are QSD DIQs. This contributes to the goal of delivering the interrupts close to the processors so as to expedite servicing of those interrupts by the processors in an efficient manner. To further expedite the handling of interrupts, the fast access mode is provided to create processor-specific space that enables fast access by the processor to the vector stored in the DIQ 480 for purposes of servicing that interrupt. These fast access CSRs (DIQs) obviate the need for processors to determine their specific processor IDs when calculating addresses of their respective DIQs.

As part of the interrupt handler procedure executed by the target processor, the sent_int registers 440 must be cleared. The sent_int registers are also processor-specific in that each register is part of the target logic controller 450 corresponding to a specific target processor. In the illustrative embodiment, each sent_int register 440 has a particular address. When a CSR write command is sent to that particular register address to clear the contents of that register, a processor ID (of the target processor) accompanies the CSR write command and is used by the PCA to determine which sent_int register should be cleared. Thus, the processor ID accompanying the CSR write command is compared to the contents of the int_target register 425 to determine which sent_int register 440 should be cleared.

According to the invention, the SMP system 100 comprises three optimizations for enhancing the servicing of interrupts: (1) delivering the interrupt vector close to the target processor, i.e., at a DIQ 480; (2) providing each processor with “fast access” to the DIQ storing the vector (i.e., without having to do table lookups) and (3) providing the processor with “fast access” to the sent_int register 440 without the need of a table lookup operation. The present invention is directed to allowing hot swap of a target processor while maintaining the optimized interrupt delivery/handling system. That is, if a target processor that has a plurality of interrupts pending for service fails and must be hot swapped, another processor generally cannot access the failed processor's specific address space registers at either the QSD (fast access DIQ) or the PCA (sent_int register). Thus, in order to support both the optimized interrupt delivery/handling system and hot swapping, the invention provides enhancements to enable such access.

As noted, the DIQs 480 in the QSD are “double mapped” into the processor-specific address space so that they can be accessed quickly (“fast access”) by the respective processors and into general address space so that they can be accessed by any processor designated to service the particular interrupts. The latter processor (i.e., the proxy processor) assumes servicing of interrupts that were previously handled by the target processor. To that end, the proxy processor must perform table lookup operations in order to determine which DIQ 480 has the interrupt vector and which sent_int register 440 must be cleared. The double mapping aspect of the invention allows hot swapping of a target processor without impacting the optimized interrupt handling mechanism described herein.

As opposed to the fast access address space wherein the same address is used by each processor to access its QSD DIQ, the general address space assigns a different (unique) address to each of the QSD queues. The addresses of the CSRs are preferably in standard system I/O address space. That is, instead of a processor merely reading address x (Rd x) to access the interrupt vector in its QSD DIQ, any processor may access that particular queue by initiating a read operation to the unique address of that queue (e.g., Rd A, Rd B, RdCorRd D).

If the operating system (or user) detects that a target processor must be removed from the system, the operating system nominates another proxy processor to service the interrupts targeted to the failed/swapped processor. The proxy processor executes proxy processor interrupt service code to service interrupts using general address references to the QSD DIQs; access to these queues via the general address space requires lookup operations. In essence, the proxy processor utilizes the general address space to directly access the failed target processor's DIQ 480 in the QSD.

The translation technique also provides dual decoding of a mask register in the I/O subsystem that is used to indicate pending interrupts provided to the target processor. As described herein, the mask register is preferably the sent_int register 440 associated with the target processor. The target processor completes servicing of a pending interrupt by clearing a bit in the sent_int register corresponding to that interrupt. The dual decoding technique allows the proxy processor to clear the bit of the sent_int register corresponding to a serviced interrupt through the use of an alternate sent interrupt (alt_sent_int) register 455 that is mapped to the sent_int register.

Specifically, there is a set of alt_sent_int registers 455 that enable a proxy processor to acknowledge interrupts on behalf of a hot swapped target processor. That is, there are preferably 32 alt_sent_int registers, one for each processor in the SMP system. These registers 455 preferably exist in the form of address decodes as opposed to flip-flops. To that extent, the proxy processor clears the alt_sent_int register associated with the hot swapped processor by issuing a CSR write operation to the address of that register 455. The alt_sent_int register address is decoded by an address decoder 458 within the PCA to a corresponding target logic controller 450 of the PCA.

Essentially, the decoder 458 functions to assume one of two algorithmic “paths”: (1) if address=sent_int register, then compare the contents of the int target register 425 with the processor ID accompanying the CSR write operation. (2) else, if address=alt_sent_int register, then compare the contents of the int_target register with address bits <10-6>. Note that each CSR write operation includes the address of the PCA register being accessed (e.g., via a write operation).

In summary, the interrupt delivery/handling system is provided to deliver interrupts to a target processor. The interrupt delivery/handling system involves optimizations that essentially create processor-specific address spaces at the QSD and PCA. To facilitate operation in a hot swap environment, the interrupt delivery/handling system is configured to operate with a proxy processor as well as with the originally targeted processor. To that end, general address space mapping is provided to enable dual mapping of the QSD DIQs, while the alt sent_int decodes are provided to enable dual decoding of the sent_int register function in the PCA. Through the use of these two inventive mechanisms, an alternate processor can function as a proxy to a hot-swapped processor and “drain” the interrupt pipeline of the hot-swapped processor by servicing its pending interrupts.

The PCA includes a mechanism that allows the proxy processor to clear interrupt bits associated with the hot-swapped target processor. Each processor has an associated sent_int register, whose contents indicate which pending interrupts have been sent to the target processor. Typically, a processor completes interrupt processing by clearing a bit in its associated sent_int register. The PCA also includes alt_sent_int registers, each associated with a processor. Access (e.g., a write operation) to these registers by another processor has the same effect as the writing of the sent_int register by the target processor.

During the hot-swap procedure, the operating system also reassigns the mask bits of the int_enable register corresponding to the hot-swapped processor to the proxy processor associated with another target logic controller as the remaining (e.g., three) target processors continue to service the pending interrupts. Thereafter, the operating system can reassign the int_target register contents of the hot-swapped processor to the proxy processor. In addition, the operating system instructs the proxy processor to execute a hot-swap routine that employs the “slow access” (i.e., general address space) DIQ mapping. Note that during normal operation, the target processor executes a routine that allows “fast access” to the QSD DIQs.

The foregoing description has been directed to specific embodiments of the present invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed is:

1. An interrupt delivery/handling system for use with a multiprocessor computer system having a plurality of processors and one or more input/output (I/O) subsystems configured to operate with one or more devices capable of issuing interrupts, the interrupt delivery/handling system comprising:
a device interrupt queue (DIQ) associated with a target processor and accessible by both the target processor and at least one other processor, the DIQ having one or more entries for storing interrupts sent to the target processor for servicing, wherein
each DIQ entry is mapped to both a first address that is specific to the target processor for permitting fast access of the interrupts by the target processor and a second address that is a general system address, and
in support of hot swapping of the target processor, interrupts stored at the target processor's DIQ can be accessed for servicing by a proxy processor by using the general system addresses.

2. The interrupt delivery/handling system of claim 1 wherein the processors have corresponding processor identifiers (IDs) and the first, target processor-specific address does not include the target processor's ID.

3. The interrupt delivery/handling system of claim 2 wherein the second, general system address includes a processor ID.

4. The interrupt delivery/handling system of claim 3 wherein the proxy processor utilizes the target processor's ID to access the interrupts stored in the target processor's DIQ.

5. The interrupt delivery/handling system of claim 4 wherein the DIQ is local to the target processor to optimize interrupt servicing.

6. The interrupt delivery/handling system of claim 1 further comprising a target logic controller associated with the target processor, the target logic controller in communicating relationship with one or more of the devices issuing the interrupts and with the multiprocessor computer system, the target logic controller having a sent interrupt register that is set when a given interrupt is sent to the target processor for servicing, and cleared when the given interrupt has been serviced, whereby the sent interrupt register can be cleared either by operation of the target processor or, in support of hot swapping of the target processor, by operation of the proxy processor.

7. The interrupt delivery/handling system of claim 6 wherein the target logic controller further includes an interrupt target register for storing the target processor's ID, and the interrupt delivery/handling system further comprises an address decoder logic configured, in response to a command having a processor ID, to clear the sent interrupt s register provided that the processor ID of the command matches the processor ID stored at the interrupt target register.

8. The interrupt delivery/handling system of claim 7 further comprising an alternate sent interrupt register that is mapped to the sent interrupt register and is configured to enable the proxy processor to clear the sent interrupt register associated with the target processor.

9. The interrupt delivery/handling system of claim 8 wherein the proxy processor clears the alternate sent interrupt register in order to have the sent interrupt register associated with the target processor cleared.

10. A method for delivering and handling interrupts to support hot swapping in a multiprocessor computer system having a plurality of processors and one or more input/output (I/O) subsystems configured to operate with one or more devices capable of issuing interrupts, the method comprising the steps of:
providing a device interrupt queue (DIQ) having a plurality of entries configured to store interrupts to be serviced by a target processor associated with the DIQ;
mapping each DIQ entry to both a first address that is specific to the target processor for permitting fast access of the interrupts by the target processor and a second address that is a general system address;
nominating a proxy processor to service the interrupts stored at the DIQ to support hot swapping of the target processor; and
configuring the proxy processor to use the general system address to access interrupts stored in the DIQ for servicing by the proxy processor.

11. The method of claim 10 further comprising the steps of:
providing a sent interrupt register associated with the target processor;
setting the sent interrupt register when an interrupt is sent to the target processor for servicing;
clearing the sent interrupt register when an interrupt sent to the target processor is serviced.

12. The method of claim 11 further comprising the step of configuring the proxy processor, in support of hot swapping of the target processor, to clear the sent interrupt register upon servicing an interrupt from the target processor's DIQ.

13. The method of claim 12 further comprising the steps of:
providing an alternative sent interrupt register associated with the proxy processor; and
clearing the sent interrupt register in response to the proxy processor accessing the alternative sent interrupt register.

14. The method of claim 13 wherein the proxy processor accesses the alternative sent interrupt register through a write operation.

15. The method of claim 14 further comprising the steps of:
providing an interrupt enable register associated with the target processor;
configuring the interrupt enable register to specify the interrupts to be sent to the target processor for servicing; and
in support of hot swapping of the target processor, clearing the interrupt enable register to prevent interrupts from being sent to the target processor for servicing.
